(19) United States
(12) Patent Application Publication
(10) Pub. No.: US 2002/0147941 A1
(43) Pub. Date: Oct. 10, 2002

(54) Network based BIOS recovery method

(76) Inventor: Robert Gentile, Boise, ID (US)

Correspondence Address: DICKSTEIN SHAPIRO MORIN & OSHINSKY LLP, 2101 L STREET NW, WASHINGTON, DC, 20037-1526, US

(21) Appl. No.: 09/825,997

(22) Filed: Apr. 5, 2001

(51) Int. Cl. G06F 11/00

(52) U.S. Cl. 714/36

(57) ABSTRACT

A system and method for recovering a corrupted BIOS from a recovery server. A computer system performs a validity test on the BIOS at startup. If the BIOS fails the validity test, the computer system connects to a recovery server over a communications network, transmits its system information and downloads an uncorrupted version of its BIOS. The computer system then overwrites the corrupted BIOS with the uncorrupted BIOS.

### BACKGROUND OF THE INVENTION

When a computer is turned on, the first action the CPU takes is to send a message to activate the Basic Input and Output System (BIOS). The BIOS then runs a series to tests, called the POST (Power On Self Test), to make sure that the system devices are working correctly. These tests generally include: 1) initializing system hardware and chipset registers; 2) initializing power management; 3) testing RAM; 4) enabling the keyboard; 5) testing serial and parallel ports; 6) initializing floppy disk drives and hard disk controllers; and 7) displaying system summary information. The BIOS enables the essential functions for the computer to operate.

If a computer's BIOS is corrupted, it can not function. However, typical computer system system BIOSes have the capability of restoring a valid BIOS image in the event that they become corrupt. This is accomplished by storing a recovery program in a block of flash memory that is not in-system writable, thus insuring that the recovery program cannot become corrupt. The recovery program is usually a small, simple piece of code that has the ability of initializing just enough system hardware to retrieve a new code image from a floppy disk or other removable media.

The problem with using removable media is that at the time this type of crisis occurs, most users do not have a disk available with the BIOS, and all of the files necessary for recovery on it. If there is no other functional computer around with which to create one, then the user will have to wait for one to be delivered from the company where the machine was purchased.

Therefore, there exists a need and desire for a system and method that will allow a user to recover a corrupted BIOS without a disk containing the computer system's BIOS.

### BRIEF SUMMARY OF THE INVENTION

The present invention mitigates the problems associated with the prior art and provides a unique system and method for recovering a corrupt BIOS over a modem, ISP, WAN, LAN, or the Internet.

In accordance with an exemplary embodiment of the present invention, a computer's BIOS recovery program has the minimum necessary software built into the flash Boot Block to interface the hardware, connect to a recovery server, download an uncorrupted version of the BIOS and flash the new BIOS. If the computer is connected to a recovery server, for example, through a LAN, the BIOS recovery program will initialize the base chipset, base RAM, and the network card. Additional functions can be included in the BIOS recovery program, for example, the utility that performs the flash programming, but since conserving ROM space is usually a concern, this utility as well as any other utilities necessary to replace the corrupted BIOS are stored on the recovery server.

### BRIEF DESCRIPTION OF THE DRAWINGS

FIG. 1 is an illustration of the various methods of access to a recovery server;

FIG. 2 is a flowchart of the program flow for a recovery program;

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to make and use the invention, and it is to be understood that structural changes may be made and equivalent structures substituted for those shown without departing from the spirit and scope of the present invention.

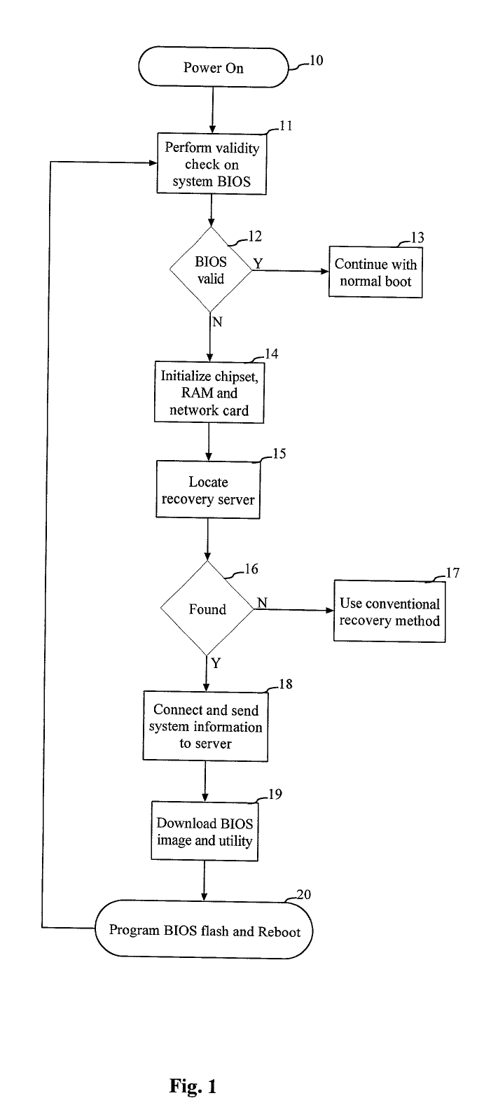

In accordance with the present invention, a computer system can recover from a corrupted BIOS by using a LAN, WAN, modem, ISP or the Internet. FIG. 1 illustrates a LAN/WAN recovery BIOS. When a computer system with a LAN/WAN recovery BIOS is turned on at initialization segment 10, the first operation the computer system performs is to perform a validity check on the system BIOS at segment 11. The computer system can determine if the BIOS image is intact by calculating a checksum or any other method known in the art for determining if a piece of code is corrupted.

If the code is valid as detected at processing segment 12, the computer system performs a normal boot at segment 13. If the code is not valid as detected at processing segment 12, the computer system initializes the chipset, RAM and network card at segment 14. A typical chipset—which controls the flow of data between the CPU, motherboard bus and the system memory—is an Intel 430HX PCIset for Pentium processors, but any chipset may be used.

The computer system then attempts to locate the recovery server at segment 15. One method known in the art for locating a computer on a LAN or WAN is to have a predetermined network name associated with the recovery server. Other methods that are known in the art can also be used. If the recovery server is not found as detected at processing segment 16, the computer system uses a conventional recovery method, i.e. prompting the user to insert a disk with an uncorrupted version of the BIOS on it, at segment 17.

If a recovery server is found as detected at processing segment 18, the computer system connects and sends its system information to the recovery server at segment 18. The computer system then downloads the BIOS image and utility at segment 19. Finally, the computer system programs the BIOS chip with the uncorrupted BIOS and reboots at segment 20. The computer system then returns to segment 11 to perform the BIOS validity check again upon reboot.

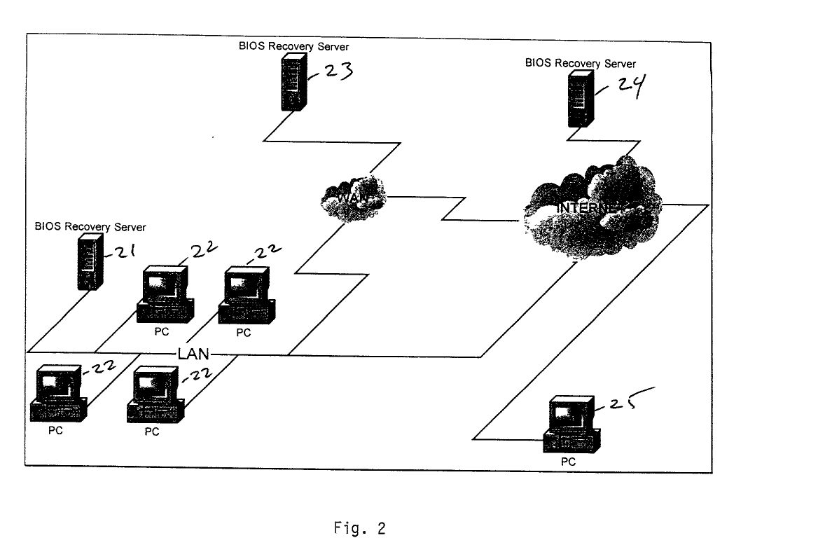

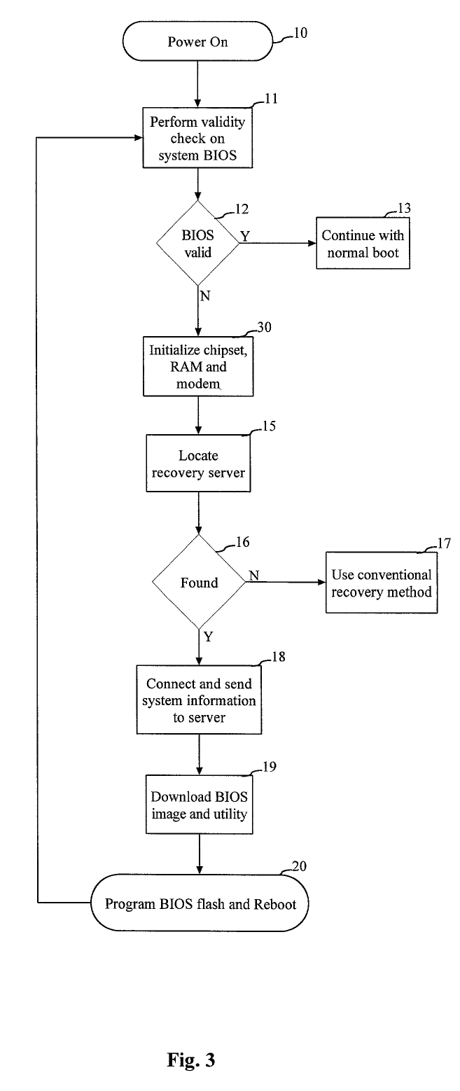

A computer system can recover from a corrupted BIOS without an uncorrupted version of the BIOS on a floppy disk even if the computer system is not connected to a LAN or WAN. FIG. 2 illustrates the various methods a computer system can use to retrieve an uncorrupted version of its BIOS when not connected to a LAN or WAN. Computer systems 22 and 25 can connect to BIOS recovery server 24 over the internet. When computer system 25 connects to BIOS recovery server 24 over the internet computer system 25 uses a modem to connect to the internet instead of a network card to connect to a LAN or WAN, so it will initialize a modem instead of a network card in segment 14 and when the computer system connects to a recovery server in segment 18, it will connect using the modem, not a network card.

While the invention has been described with reference to an exemplary embodiments various additions, deletions, substitutions, or other modifications may be made without departing from the spirit or scope of the invention. Accordingly, the invention is not to be considered as limited by the foregoing description, but is only limited by the scope of the appended claims.

What is claimed as new and desired to be protected by Letters Patent of the United States is:

1. A method of recovering a corrupt computer system BIOS comprising the steps of:
checking the validity of a computer system's BIOS upon startup;
continuing with a normal boot if said BIOS is valid;
if said BIOS is not valid:
initializing components of said computer system sufficient to establish a communications connection with a recovery server;
locating said recovery server;
connecting to said recovery server and sending system information to said recovery server;
downloading an uncorrupted BIOS from said recovery server;
programming said uncorrupted BIOS onto said computer system's BIOS storage area; and
rebooting.

2. A method as in claim 1, wherein one of said components is a network card.

3. A method as in claim 2, wherein said computer system connects to said recovery server over a local area network.

4. A method as in claim 2, wherein said computer system connects to said recovery server over a wide area network.

5. A method as in claim 2, wherein said computer system connects to said recovery server over the internet.

6. A method as in claim 1, wherein one of said components is a modem.

7. A method as in claim 6, wherein said computer system connects to said recovery server over a direct dial connection.

8. A method as in claim 6, wherein said computer system connects to said recovery server though an internet service provider.

9. A method as in claim 6, wherein said computer system connects to said recovery server over the internet.

10. A method of recovering a corrupt computer system BIOS comprising the steps of:
receiving at a server a request for an uncorrupted BIOS transmitted by a computer system with a corrupted BIOS;
receiving system information from said computer system; and
transmitting an uncorrupted BIOS to said computer system.

11. A method as in claim 10, wherein said server and said computer system are connected over a local area network.

12. A method as in claim 10, wherein said server and said computer system are connected over a wide area network.

13. A method as in claim 10, wherein said server and said computer system are connected over the internet.

14. A method as in claim 10, wherein said server and said computer system are connected through said computer system's modem.

15. A method for recovering a corrupt BIOS comprising the steps of:
checking the validity of a computer system's BIOS upon startup;
continuing with a normal boot if said BIOS is valid;
if said BIOS is not valid:
initializing components of said computer system sufficient to establish a communications connection with a recovery server;
locating a recovery server;
connecting to said recovery server and sending system information to said recovery server;
transmitting an uncorrupted BIOS and utility from said recovery server to said computer system;
receiving said uncorrupted BIOS and utility at said computer system;
programming said uncorrupted BIOS onto said computer system's BIOS storage area; and
rebooting.

16. A method as in claim 15, wherein one of said components is a network card.

17. A method as in claim 16, wherein said server and said computer system are connected over a local area network.

18. A method as in claim 16, wherein said server and said computer system are connected over a wide area network.

19. A method as in claim 16, wherein said server and said computer system are connected over the internet.

20. A method as in claim 15, wherein one of said components is a modem.

21. A method as in claim 20, wherein said server and said computer system are connected over a direct dial connection.

22. A method as in claim 20, wherein said server and said computer system are connected over an internet service provider.

23. A method as in claim 20, wherein said server and said computer system are connected over the internet.

24. A system for recovering a corrupted computer system BIOS comprising:
a computer system, said computer system comprising a processor, a BIOS recovery program, a BIOS storage area containing said BIOS, RAM, a first communications system and a chipset to control the flow of data between the processor, the motherboard bus and the RAM; and
a recovery server, comprising a processor, a storage medium containing an uncorrupted copy of said computer system's BIOS, and a second communications system;
wherein said computer system processor, in response to detecting a BIOS failure, executes said BIOS recovery program and initializes said computer system's chipset, RAM, and first communications system, locates said recovery server, connects to said recovery server through said first and second communications systems, sends system information to said recovery server, downloads from said recovery server an uncorrupted BIOS, stores said uncorrupted BIOS into said BIOS storage area and reboots.

25. A system as in claim 24, wherein said first and second communications system are network cards.

26. A system as in claim 25, wherein said computer system and said recovery server are connected over a local area network.

27. A system as in claim 25, wherein said computer system and said recovery server are connected over a wide area network.

28. A system as in claim 25, wherein said computer system and said recovery server are connected over the internet.

29. A system as in claim 24, wherein said first and second communications systems are modems.

30. A system as in claim 29, wherein said computer system and said recovery server are connected though an internet service provider.

31. A system as in claim 29, wherein said computer system and said recovery server are connected over the internet.

32. A system for recovering a corrupted computer system BIOS comprising:
a computer system, said computer system comprising a processor, a BIOS recovery program, a BIOS storage area containing said BIOS, RAM, and a first communications system and a chipset to control the flow of data between the processor, the motherboard bus and the RAM;
wherein said computer system's processor, in response to detecting a BIOS failure, executes said BIOS recovery program and initializes said computer system's chipset, RAM, and first communications system, locates a recovery server, connects to said recovery server through said first communications system, sends system information to said recovery server, downloads from said recovery server an uncorrupted BIOS, stores said uncorrupted BIOS into said BIOS storage area and reboots.

33. A system as in claim 32, wherein said first communications system is a network card.

34. A system as in claim 33, wherein said computer system and said recovery server are connected over a local area network.

35. A system as in claim 33, wherein said computer system and said recovery server are connected over a wide area network.

36. A system as in claim 33, wherein said computer system and said recovery server are connected over the internet.

37. A system as in claim 32, wherein said first communications system is a modem.

38. A system as in claim 37, wherein said computer system and said recovery server are connected over an internet service provider.

39. A system as in claim 37, wherein said computer system and said recovery server are connected over the internet.

40. A system for recovering a corrupted computer system BIOS comprising:
a recovery server, said recovery server comprising a processor, a hard drive containing an uncorrupted copy of a computer system's BIOS, and a first communications system;
wherein said recovery server, in response to receiving a request transmitted by a computer system with a corrupted BIOS, connects to said computer system, receives system information from said computer system and transmits said uncorrupted BIOS to said computer system.

41. A system as in claim 40, wherein said first communications system is a network card.

42. A system as in claim 41, wherein said recovery server and said computer system are connected over a local area network.

43. A system as in claim 41, wherein said recovery server and said computer system are connected over a wide area network.

44. A system as in claim 41, wherein said recovery server and said computer system are connected over the internet.

45. A system as in claim 40, wherein said first communications system is a modem.

46. A system as in claim 45, wherein said recovery server and said computer system are connected though an internet service provider.

47. A system as in claim 45, wherein said recovery server and said computer system are connected over the internet.

48. A system for recovering a corrupted computer system BIOS comprising:
a computer system, said computer system comprising components sufficient to enable recovery of an uncorrupted BIOS from a remote server;
wherein said computer system, in response to detecting a BIOS failure, utilizes said components to connect to a remote server, receives an uncorrupted BIOS from said remote server, stores said uncorrupted BIOS and reboots.
